(19) United States
(12) Patent Application Publication
(10) Pub. No.: US 2022/0120062 A1
(43) Pub. Date: Apr. 21, 2022

(54) ESCUTCHEON

(71) Applicant: Reliance Worldwide Corporation, Atlanta, GA (US)

(72) Inventors: Linda FECHNER, Madison, AL (US); Virgil O'NEIL, San Diego, CA (US); Clayton BOARDMAN, Atlanta, GA (US); Alexander RYCROFT, Atlanta, GA (US)

(73) Assignee: Reliance Worldwide Corporation, Atlanta, GA (US)

(21) Appl. No.: 17/422,708

(22) PCT Filed: Jan. 16, 2020
(86) PCT No.: PCT/US2020/013906

§ 371 Date: Jul. 13, 2021

Related U.S. Application Data
(60) Provisional application No. 62/793,612, filed on Jan. 17, 2019.

(51) Int. Cl. E03C 1/042; F16L 5/10

(52) U.S. Cl. CPC E03C 1/042; E03C 2201/50; F16L 5/10

(57) ABSTRACT

A covering is provided to cover an opening in a surface through which a tubular member extends. The covering includes a base of a predetermined thickness and which is larger in diameter than the tubular member. The base defines an aperture which coincides with a central axis of the base. The base has a medial portion which tapers such that an outer diameter of the medial portion exceeds an inner diameter of the medial portion adjacent to the aperture. The aperture coincides with a central axis of the medial portion. A ring is disposed between the inner diameter of the medial portion and the aperture. A plurality of teeth are arranged circumferentially around the ring away from the medial portion, are spaced from each other and project inward from the medial portion, and are structured to grip the tubular member so as to secure the tubular member in place.

### CROSS-REFERENCE TO RELATED APPLICATIONS

This application claims the benefit of priority to U.S. Provisional App. No. 62/793,612 filed Jan. 17, 2019, the entire contents of which are incorporated herein by reference.

### FIELD

The present application relates generally to the field of residential and commercial plumbing systems.

### BACKGROUND

An escutcheon may be used to conceal and cover an opening in a wall where a pipe extends from a drywall surface. An escutcheon typically is slid over a pipe and is then pressed flush against the drywall surface to cover the opening around the pipe that was cut to push the pipe through the drywall.

### SUMMARY

Certain escutcheons may be structured such that they can be easily slid along the pipe if they are pulled forward from the drywall surface. Furthermore, if the pipe itself is not restrained securely behind the drywall surface, then such escutcheons would not restrict movement of the pipe either.

According to at least one implementation, an escutcheon is structured to inhibit sliding of a pipe and to be fitted securely against a drywall surface. Such an escutcheon may include a grab ring that holds the pipe in place.

According to an exemplary aspect, a covering of an opening in a surface through which a tubular member extends is provided. The covering includes a base having a predetermined thickness, the base being larger in diameter than the tubular member, the base defining an aperture which coincides with a central axis of the base. The base has a medial portion which is formed such that an outer diameter of the medial portion is larger than an inner diameter of the medial portion adjacent to the aperture, the medial portion being structured such that the aperture coincides with a central axis of the medial portion. A ring is disposed between the inner diameter of the medial portion and the aperture. A plurality of teeth are arranged circumferentially around the ring away from the medial portion, the plurality of teeth being spaced from each other and projecting inward from the medial portion, and the plurality of teeth are structured to grip the tubular member so as to secure the tubular member in place.

According to another exemplary aspect, a cover for concealing an opening in a surface surrounding a tubular member is provided. The cover includes a base positioned to be flush against the surface, and defining an aperture which is centered in a longitudinal direction of the base and in a lateral direction of the base; a medial portion extending from the base in a longitudinal direction of the tubular member, the medial portion tapering from a wider diameter proximate to the base to a narrower diameter proximate to the aperture, the base and the medial portion being structured such that the aperture extends through a center of the base and a center of the medial portion; and a ring comprising a plurality of teeth arranged radially along the ring, the plurality of teeth being disposed on a side of the ring closest to the aperture and configured to contact the tubular member at a plurality of contact locations.

According to yet another exemplary aspect, a cover is provided including a base in which an opening is provided. The opening is centered in a longitudinal direction of the base and in a lateral direction of the base, the opening being configured to receive a tubular member through the opening. A medial portion extends from the base in a longitudinal direction of the tubular member, the medial portion having a wider diameter at a rear surface of the base and a narrower diameter at a front surface of the base opposite to the rear surface, the rear surface being configured to be flush against a wall, and the base and the medial portion being structured such that the opening extends through the base and a center of the medial portion. A plurality of teeth are arranged radially along a circumference of the opening, the plurality of teeth being configured to contact the tubular member at a plurality of contact locations.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims. In the drawings, like reference numerals are used throughout the various views to designate like components.

FIG. 1A is a perspective view of an escutcheon according to an exemplary implementation.

FIG. 1B is a front view of the escutcheon shown in FIG. 1A.

FIG. 1C is a rear view of the escutcheon shown in FIG. 1A.

FIG. 1D is a side view of the escutcheon shown in FIG. 1A.

FIG. 1E is a top view of the escutcheon shown in FIG. 1A.

FIG. 2A is a rear view of an escutcheon according to an exemplary implementation.

FIG. 2B is a side cross-section view of the escutcheon shown in FIG. 2A.

FIG. 2C is a detail view of a portion of the escutcheon shown in FIG. 2B.

FIG. 3 is a depiction of an escutcheon according to an exemplary implementation as assembled with an exemplary tubular member.

FIG. 4A is a side view of an escutcheon according to an exemplary implementation.

FIG. 4B is a side view of an escutcheon according to an exemplary implementation.

FIG. 4C is a side view of an escutcheon according to an exemplary implementation.

FIG. 4D is a side view of an escutcheon according to an exemplary implementation.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Various exemplary implementations are described hereinafter. It should be noted that the specific implementations are not intended as an exhaustive description or as a limitation to the broader aspects discussed herein. One aspect described in conjunction with a particular implementation is not necessarily limited to that implementation and can be practiced with any other implementation(s).

The following terms are used throughout and are as defined below.

As used herein and in the appended claims, singular articles such as “a” and “an” and “the” and similar references in the context of describing the elements (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein, is intended merely to better illuminate the implementations and does not pose a limitation on the scope of the claims unless otherwise stated. No language in the specification should be construed as indicating any non-claimed element as essential.

The implementations, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified. The expression “comprising” means “including, but not limited to.” Thus, other non-mentioned components or steps may be present. Unless otherwise specified, “a” or “an” means one or more.

Unless otherwise indicated, all numbers expressing quantities of properties, parameters, conditions, and so forth, used in the specification and claims are to be understood as being modified in all instances by the term “about.” Accordingly, unless indicated to the contrary, the numerical parameters set forth in the following specification and attached claims are approximations. Any numerical parameter should at least be construed in light of the number reported significant digits and by applying ordinary rounding techniques. The term “about” when used before a numerical designation indicates approximations which may vary by (+) or (−) 10%, 5% or 1%, for example.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

As discussed, escutcheons are provided to cover or conceal an opening, e.g., in a wall through which a tubular member is extended. The tubular member may be a pipe, for example, as a plumbing conduit in a commercial or residential building. Escutcheons are typically provided for aesthetic purposes, that is, to conceal an unsightly hole in a drywall surface that is cut out of the drywall surface to accommodate a pipe. An escutcheon is placed on the side of the drywall that is externally visible so as to conceal the opening.

However, such escutcheons may be not provided in a secure manner. In particular, such escutcheons may be loosely provided with a tubular member, such that they can easily become dislodged if pulled forward from the drywall surface. More specifically, the escutcheons can easily slide along the tubular member when pulled forward. Moreover, such escutcheons do not inhibit or restrict movement of the tubular member itself.

According to at least one implementation, an escutcheon is provided as a covering (a cover) that is structured to inhibit sliding of a tubular member and to be fitted securely against a drywall surface. Such an escutcheon may include a plurality of teeth that hold the tubular member in place.

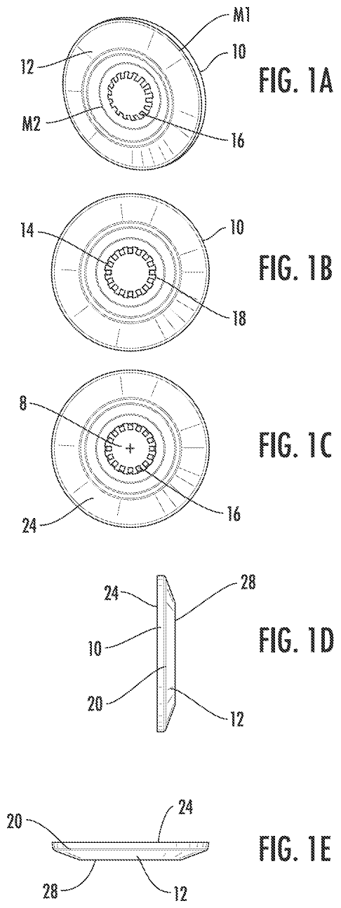

Turning to the figures, FIG. 1A is a perspective view of a covering 1 according to an exemplary implementation. The covering 1 is formed to cover of an opening in a surface through which a tubular member extends, as discussed in more detail below. The covering 1 includes a base 10 having a predetermined thickness. The base defines an aperture or opening 8 which coincides with a central axis of the base 10.

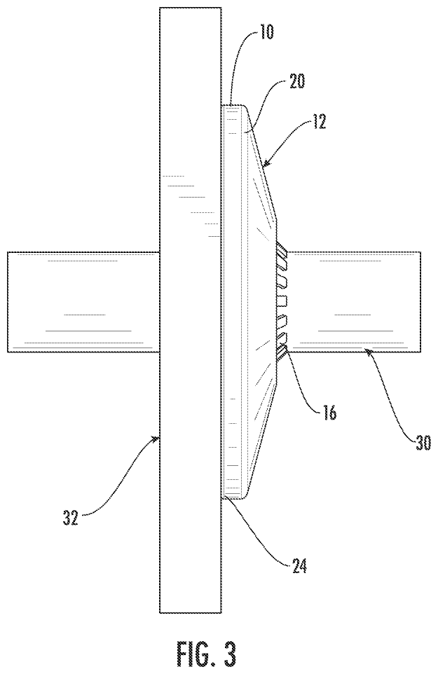

As further shown in FIG. 1A, the base 10 further includes a medial portion 12 which is formed such that an outer diameter M1 of the medial portion 12 is larger than an inner diameter M2 of the medial portion 12 adjacent to the aperture 8. The medial portion 12 is structured such that the aperture 8 coincides with a central axis of the medial portion 12. A ring 14 is disposed between the inner diameter of the medial portion M2 and the aperture 8. A plurality of teeth 16 are arranged circumferentially around the ring 14 away from the medial portion 12. In particular, the plurality of teeth 16 are spaced from each other and projecting inward from the medial portion 12. The plurality of teeth 16 are structured to grip a tubular member (e.g., tubular member 30 shown in FIG. 3) so as to secure the tubular member 30 in place.

FIG. 1B is a front view of the covering 1 shown in FIG. 1A. As shown in FIG. 1B, in some exemplary implementations, the plurality of teeth 16 may be spaced at equal intervals along a circumference of the ring 14. However, in other implementations, the teeth 16 may be irregularly or unevenly spaced. Further, as shown in FIG. 1B, indented sections or portions 18 (i.e., indents) may be provided between the teeth 16. One or more of the teeth 16 or each of the teeth 16 may project from a portion of the ring 14 that is raised relative to the indented sections 18.

FIG. 1C is a rear view of the covering 1 shown in FIG. 1A. As shown in FIGS. 1A-1C, the covering 1 may be structured such that the plurality of teeth 16 project inward from the ring 14 toward the aperture 8. The plurality of teeth 16 are structured to engage an outer surface of the tubular member (e.g., tubular member 30 shown in FIG. 3) when the tubular member moves axially toward the medial portion 12. In this manner, the plurality of teeth 16 act to inhibit or prevent movement of the tubular member. The plurality of teeth 16 are arranged around the ring 14 on a side of the medial portion 12 that is closest to the aperture 8.

FIG. 1D and FIG. 1E depict side and top views of the covering 1. As shown in FIGS. 1D and 1E, the covering 1 may be structured such that the medial portion 12 extends a portion of the base 10 that is defined by a boundary portion 20. The medial portion 12 extending from the boundary portion 20 includes a front surface 28 shown in FIG. 1E and a rear side 24.

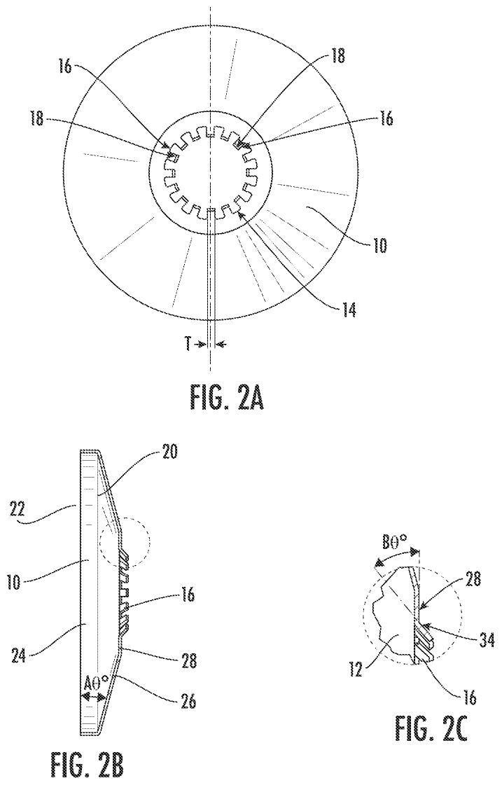

FIG. 2A is a rear view of a covering 1 according to an exemplary implementation. The medial portion 12 of the covering 1 is arranged with the plurality of teeth 16 such that the plurality of teeth may be inclined relative to the front surface 28. The front surface 28 is structured such that the aperture 8 penetrates through the front surface 28 from the rear side 24. The rear side 24 (a back side) forms a continuous planar surface. In other words, in at least some implementations, the rear side 24 may be relatively flat, in contrast to the medial portion 12.

Further, as shown in FIG. 2A, the plurality of teeth 16 may be inclined inclined toward the central axis of the medial portion 12. In this manner, as shown in FIG. 3, the plurality of teeth 16 may be arranged with the tubular member 30 so as to contact the tubular member 16 at a position which is offset from the aperture 8. As shown in FIG. 2A, the plurality of teeth 16 may be constructed such that one or more of the teeth 16 has a tooth diameter T. The tooth diameter T may be selected to be proportional to the diameter of the aperture 8 in some implementations. In some embodiments, approximately 16 teeth may be provided so as to be arranged at equal intervals around the aperture 8.

FIG. 2B is a side cross-section view of the covering 1 shown in FIG. 2A. As shown in FIG. 2A, the thickness of the base portion 10 that does not include the medial portion, i.e., a portion of the base 10 defined between the rear side 24 and the boundary portion 20, may be narrower than the medial portion 12 in one or more implementations. The medial portion 12 may have a slope 26 which is a taper from the boundary portion 20 to the front surface 28 of the medial portion 12 where the teeth 16 are arranged. In some implementations, the angle Aθ of the slope 26 relative to the rear side 24 may be set in accordance with a size of the aperture 8. In some embodiments, the angle Aθ may be between 5° and 25°. In particular, in some embodiments, the angle Aθ may be approximately 15°.

FIG. 2C is a detail view of a portion of the covering 1 shown in FIG. 2B. As shown in FIG. 2C, in some implementations, the plurality of teeth 16 may be inclined so as to project at an angle Bθ with respect to the front surface 28 of the medial portion. One or more teeth of the plurality of 16 may have a sidewall 30 that is inclined at the angle Bθ with respect to the front surface 28. In some embodiments, the angle Bθ may be between 50° and 60°. In particular, in some embodiments, the angle Bθ may be approximately 40°.

FIG. 3 shows the covering 1 according to an exemplary implementation as assembled with tubular member 30. The tubular member 30 penetrates through the covering 1 so as to extend from the rear side 24 of the base 10 through the aperture 8. The covering 1 may be positioned so as to be flush against a wall 32 that may be, but is not limited to, a drywall surface. FIG. 3 is a side view of the covering 1 as arranged with the tubular member 30 and the wall 32. The covering 1 is configured to slide over the tubular member 30 when installed so as to be flush with the wall 32. The base 10, the medial portion 12, and the ring 14 of the covering 1 are arranged concentrically around the tubular member 30 as viewed from the front of the covering 1 when the covering 1 is installed over the tubular member 30.

As understood from FIG. 3, the opening in the wall 32 through which the tubular member 30 is provided is completely concealed by the covering 1. The medial portion 12 extends from the base 10 in a longitudinal direction of the tubular member 30. As shown in FIG. 3, the teeth 16 are configured to contact the tubular member 30 at a plurality of contact locations, i.e., contact points where at least a portion of the teeth 16 (e.g., at least the tips and interior sides of the teeth 16) contact the tubular member 30.

The plurality of teeth 16 exert a frictional force on the tubular member 30 when the tubular member is moved in the longitudinal direction of the tubular member 30. In this manner, the teeth 16 may inhibit or prevent movement of tubular member 30 if tubular member 30 is pulled forward from the wall 32, or backward movement if the tubular member is not restrained and subject to backward movement with respect to the wall 32. In particular, when the tubular member 30 is pushed back toward the wall 32, the teeth 16 dig into the tubular member to impede motion of the tubular member 30.

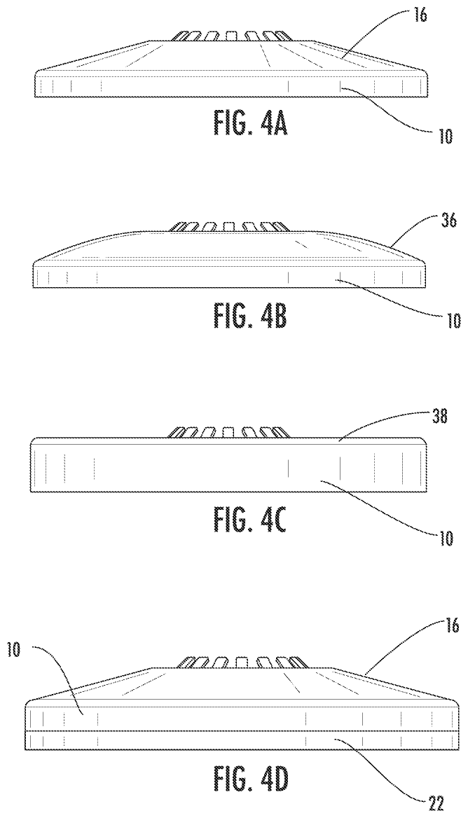

FIG. 4A is a front view of a covering 1 according to an exemplary implementation. In some implementations, the base 10 is positioned to be flush against the surface of wall 32 (e.g., a front surface), and defines the aperture 8 so the aperture 8 may be centered in both longitudinal and lateral directions of the base 10. In some implementations, the medial portion 12 may taper from a wider diameter proximate to the base 10 to a narrower diameter proximate to the aperture 8, which extends through a center of the base 10 and a center of the medial portion 12. The teeth 16 may be arranged at part of the medial portion 12 which is closest to the aperture 8.

Furthermore, in some implementations, the ring 14 is the portion of the front surface 28 of the medial portion 12 which is at a periphery of the aperture 8. In other words, in some implementations, the ring 14 is part of the medial portion 12, and the plurality of teeth 16 are constructed at the periphery of the medial portion 12. In some implementations, on the other hand, the ring 14 may be grab ring that is attached to the medial portion 12. Additionally, in some implementations, the base 10, the medial portion 12, and the plurality of teeth 16 are formed as a single, unitary structure. In other words, the base 10, the medial portion 12, and the plurality of teeth 16 may be formed as a single piece according to certain implementations.

Referring to FIG. 4A again, the covering 1 shown in FIG. 4A includes a medial portion 12 which is tapered, as described above. In particular, the medial portion 12 may be tapered so as to have a slope 26 relative to the rear side 24 of the base 10. However, in some implementations, the covering 1 may not be tapered, but may have a variety of other configurations.

For example, FIG. 4B depicts a covering 1 in which the medial portion 12 is domed, i.e., the medial portion 12 has a curved surface 36. Further, as shown in FIG. 4C, the covering 1 may be structured such that the medial portion 12 is extruded from the base 10, where an extruded surface 38 of the medial portion 12 is the visible surface of the covering 1 when viewed from the front.

In some implementations, the covering 1 may be constructed from electro-less nickel plated steel. In some implementations, the covering 1 may include acoustical dampening materials. FIG. 4D is a side view of a covering 1 according to an exemplary implementation including acoustic dampening material provided in a sheet 22. In some implementations, a sheet of acoustic dampening material may be adhered to the rear side 24 of the base 10 so as to be positioned between the rear side 24 and the wall 32 (i.e., at a mating surface between the rear side 24 of base 10 and the wall 32) when the covering 1 is installed on the tubular member. The acoustic dampening material may mitigate noise and vibration. By reducing or mitigating vibration, the acoustic dampening material may further contribute together with the plurality of teeth 16 to helping the tubular member 30 remain in place. In some implementations, the acoustic material may include but is not limited to thermoplastic elastomer, thermoplastic rubber, other pliable materials, acoustic caulking, or combinations of one or more of the foregoing.

Further still, in some implementations, a firestopping material may be disposed between the rear surface 24 and the wall 32. The firestopping material may be arranged between the wall 32 and the rear side 24 such that when the tubular member 30 is moved, the teeth 16 grip the tubular member 30 and force the firestopping material against the wall 32. The firestopping material may include but is not limited to intumescent material, non-intumescent material, or combinations thereof. Additionally, in some implementations, a combination of acoustical and firestopping material may be provided between the wall 32 and the rear side 24 of the base 10. The sheet 22 may, for example, including one or more of a firestopping material and an acoustic dampening material.

In some implementations, a method of constructing a covering 1 is provided. The method may include forming a plurality of teeth 16 into a circular arrangement, e.g., to be disposed around ring 14. The method may further include integrating the teeth 16 into a medial portion 12 which is connected to a base 10. In some implementations, the method may include constructing one or more of the base 10, the medial portion 12 and the teeth 16 from cold-rolled electro-less nickel plated steel. In some implementations, the method includes forming the base 10, the medial portion 12 and the teeth 16 in a single integrated one-piece covering 1.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is to be understood that to the extent that the present disclosure refers to certain preferred implementations, various other implementations and variants may occur to those skilled in the art, which are within the scope and spirit of the disclosure, and such other implementations and variants are intended to be covered by corresponding claims. Those skilled in the art will readily appreciate that many modifications are possible (e.g., variations in sizes, dimensions, structures, shapes and proportions of the various elements, mounting arrangements, use of materials, orientations, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A covering of an opening in a surface through which a tubular member extends, comprising:
a base having a predetermined thickness, the base being larger in diameter than the tubular member, the base defining an aperture which coincides with a central axis of the base;
the base having a medial portion which is formed such that an outer diameter of the medial portion is larger than an inner diameter of the medial portion adjacent to the aperture, the medial portion being structured such that the aperture coincides with a central axis of the medial portion;
a ring disposed between the inner diameter of the medial portion and the aperture; and
a plurality of teeth arranged circumferentially around the ring away from the medial portion, the plurality of teeth being spaced from each other and projecting inward from the medial portion, and the plurality of teeth being structured to grip the tubular member so as to secure the tubular member in place.

2. The covering of claim 1, wherein the plurality of teeth are spaced at equal intervals along a circumference of the ring.

3. The covering of claim 1, wherein the plurality of teeth project inward from the ring toward the aperture.

4. The covering of claim 1, wherein the plurality of teeth are structured to engage an outer surface of the tubular member when the tubular member moves axially toward the medial portion.

5. The covering of claim 1, wherein the plurality of teeth are arranged around the ring on a side closest to the aperture.

6. The covering of claim 1, wherein:
the medial portion comprises a front side where the plurality of teeth are inclined and which further defines the aperture, and a back side which forms a continuous planar surface.

7. The covering of claim 1, wherein:
the plurality of teeth are inclined toward the central axis of the medial portion so as to contact the tubular member at a position which is offset from the aperture.

8. A cover for concealing an opening in a surface surrounding a tubular member, the cover comprising:
a base positioned to be flush against the surface, and defining an aperture which is centered in a longitudinal direction of the base and in a lateral direction of the base;
a medial portion extending from the base in a longitudinal direction of the tubular member, the medial portion tapering from a wider diameter proximate to the base to a narrower diameter proximate to the aperture, the base and the medial portion being structured such that the aperture extends through a center of the base and a center of the medial portion; and
a ring comprising a plurality of teeth arranged radially along the ring, the plurality of teeth being disposed on a side of the ring closest to the aperture and configured to contact the tubular member at a plurality of contact locations.

9. The cover of claim 8, wherein the teeth are structured to engage an outer surface of the tubular member when the tubular member moves toward the base.

10. The cover of claim 8, wherein the cover is structured to slide over the tubular member.

11. The cover of claim 8, wherein the plurality of teeth exert a frictional force on the tubular member when the tubular member is moved in the longitudinal direction of the tubular member.

12. The cover of claim 8, wherein the ring comprises indented portions located between the teeth.

13. The cover of claim 12, wherein each tooth projects from a portion of the ring that is raised relative to the indented portions.

14. The cover of claim 12, wherein the base, the medial portion, and the ring are arranged concentrically around the tubular member.

15. The cover of claim 8, wherein the base, medial portion, and the plurality of teeth are integrally formed as one piece.

16. A cover comprising:
a base in which an opening is provided, the opening being centered in a longitudinal direction of the base and in a lateral direction of the base, the opening being configured to receive a tubular member through the opening;
a medial portion extending from the base in a longitudinal direction of the tubular member, the medial portion having a wider diameter at a rear surface of the base and a narrower diameter at a front surface of the base opposite to the rear surface, the rear surface being configured to be flush against a wall, and the base and the medial portion being structured such that the opening extends through the base and a center of the medial portion; and
a plurality of teeth arranged radially along a circumference of the opening, the plurality of teeth being configured to contact the tubular member at a plurality of contact locations.

17. The cover of claim 16, wherein the medial portion is tapered.

18. The cover of claim 16, wherein the medial portion is domed.

19. The cover of claim 16, wherein the medial portion is extruded.

20. The cover of claim 16, wherein the cover comprises acoustic dampening material.
